(19) United States
(12) Patent Application Publication
(10) Pub. No.: US 2006/0033004 A1
(43) Pub. Date: Feb. 16, 2006

(54) Optical head device and adjusting method therefor

(76) Inventor: Tatsuki Wade, Nagano (JP)

Correspondence Address: CANTOR COLBURN, LLP, 55 GRIFFIN ROAD SOUTH, BLOOMFIELD, CT, 06002, US

(21) Appl. No.: 11/198,369

(22) Filed: Aug. 5, 2005

(30) Foreign Application Priority Data
Aug. 9, 2004 (JP) 2004-232720

(51) Int. Cl. G02B 27/40; G02B 27/64

(52) U.S. Cl. 250/201.5

(57) ABSTRACT

An optical head device includes a laser beam emitting element, an objective lens, a light receiving element provided with a light receiving face, a beam guide mirror for guiding the reflected light to the light receiving face, and a main body frame on which at least the light receiving element and the beam guide mirror are mounted. The light receiving face is disposed to face an incident direction of the reflected light to the objective lens and, one of the light receiving element and the beam guide mirror is disposed such that its mounting position is adjustable in parallel with the light receiving face and in two dimensional directions, and the other is disposed such that its mounting position is adjustable in parallel with the light receiving face and in one dimensional direction. An additional or second light receiving element may be provided.

### CROSS REFERENCE TO RELATED APPLICATION

The present invention claims priority under 35 U.S.C. §119 to Japanese Application No. 2004-232720 filed Aug. 9, 2004, which is incorporated herein by reference.

### FIELD OF THE INVENTION

An embodiment of the present invention may relate to an optical head device for performing recording and reproduction information to and from an optical disk such as a CD or a DVD, and to an adjusting method for the optical head device. More specifically, an embodiment of the present invention may relate to an adjusting mechanism of the mounting position of a light receiving element which is mounted in an optical head device and to an adjusting method for the mounting position of the light receiving element.

### BACKGROUND OF THE INVENTION

An optical head device which performs recording and reproduction information to and from an optical disk such as a CD or a DVD includes a laser beam emitting element, an objective lens for converging the laser beam emitted from the laser beam emitting element to the optical disk, a raising mirror for raising the laser beam toward the objective lens, a light receiving element having a light receiving face which receives a reflected light from the optical disk, a main body frame on which the laser beam emitting element, the light receiving element, a prescribed optical system, etc., are mounted, and the like. One of conventional optical head devices has been known which is provided with a beam guide mirror for guiding the reflected light to the light receiving face of the light receiving element and in which the light receiving element is disposed on the upper face side facing the optical disk (see, for example, Japanese Patent Laid-Open No. 2003-272220).

In the optical head device disclosed in the prior art, the light receiving element is disposed on the upper face side facing the optical disk. In other words, the light receiving face of the light receiving element is disposed so as to face the incident direction (downward direction) of the reflected light to the objective lens. Therefore, the reflected light from the optical disk which is guided to the light receiving face of the light receiving element by the beam guide mirror is deflected by the raising mirror in parallel with the disk face of the optical disk to pass on the bottom face side of the main body frame. Accordingly, the objective lens can be disposed so as to bring closer to the bottom face side of the main body frame in comparison with the optical head device in which the light receiving face of the light receiving element is disposed so as to face upward, and thus the thickness of the optical head device can be made thinner.

Further, since the light receiving element is generally formed in a flat shape in which the outside dimension perpendicular to the thickness direction is large in comparison with that of the thickness direction. Therefore, the optical head device described in the prior art can be made thinner even in comparison with the optical head device in which the light receiving face of the light receiving element is disposed in parallel with the incident direction of the reflected light to the objective lens, i.e., the light receiving element is disposed on the side face.

In the optical head device disclosed in the prior art, the adjustment of the mounting position of the light receiving element is performed such that a laser beam is emitted from a laser beam emitting element and the reflected light beam from the optical disk is detected while the optical disk is rotated. In a state that the optical disk is rotating, the light receiving element cannot be accessed from the upper face side. Therefore, in the optical head device disclosed in the prior art, through-holes are formed at two positions of the main body frame and adjustment of the mounting position of the light receiving element is performed by using the through-holes. Concretely, the light receiving element which is temporarily fixed to the main body frame is adjusted in itself in three dimensional direction by two adjusting pins which are inserted into the through-holes from the bottom face side of the main body frame. Then the light receiving element having been adjusted in three dimensional directions is fixed to the main body frame in three dimensional directions with an adhesive.

As described above, the optical head device disclosed in the prior art is disposed such that the light receiving face of the light receiving element faces in the downward direction and thus the thickness of the device can be reduced. However, the adjustment of the mounting position of the light receiving element is performed such that the light receiving element is adjusted in three dimensional directions by using the through-holes formed in the main body frame, and thus the following problems may occur.

First, since the light receiving element is adjusted in three dimensional directions, an adjusting time to be required becomes longer and further a stable adjustment can not be attained. In addition, since the light receiving element is fixed to the main body frame in a three dimensional manner with an adhesive, the mounting position of the light receiving element is easy to vary due to the temperature variation and its reliability decreases.

Further, since the adjusting pins are inserted into the through-holes from the bottom face side of the main body frame to adjust the position of the light receiving element which is disposed on the upper face side, long adjusting pins are required. Further, since the position of the light receiving element is adjusted by using two adjusting pins, the light receiving element is supported at two positions and thus adjusting operations are not stable. Further, the adjusting operations are performed in the state where the adjusting pins are inserted into the through-holes and the adjusting portion of the light receiving element cannot be inspected with visual observation because an optical disk is present on the upper face side of the main body frame, and thus the workability of the adjusting operations is not satisfactory.

### SUMMARY OF THE INVENTION

In view of the problems described above, an embodiment of the present invention may advantageously provide an optical head device in which the mounting position of a light receiving element is easily and stably adjustable. Further, an embodiment of the present invention may advantageously provide an adjusting method for an optical head device in which the mounting position of a light receiving element is easily and stably adjustable.

Thus, according to an embodiment of the present invention, there may be provided an optical head device including a laser beam emitting element, an objective lens for converging a laser beam which is emitted from the laser beam emitting element to an optical disk, a light receiving element which is provided with a light receiving face for receiving a reflected light from the optical disk, a beam guide mirror for guiding the reflected light to the light receiving face, and a main body frame on which at least the light receiving element and the beam guide mirror are mounted. In this optical head device, the light receiving face of the light receiving element is disposed to face an incident direction of the reflected light to the objective lens, and one of the light receiving element and the beam guide mirror is disposed such that its mounting position is adjustable in parallel with the light receiving face and in two dimensional directions and the other of the light receiving element and the beam guide mirror is disposed such that its mounting position is adjustable in parallel with the light receiving face and in one dimensional direction.

In accordance with an embodiment of the present invention, one of the light receiving element and the beam guide mirror is disposed such that its mounting position is adjustable in parallel with the light receiving face and in two dimensional directions and the other of the light receiving element and the beam guide mirror is disposed such that its mounting position is adjustable in parallel with the light receiving face and in one dimensional direction. Therefore, the mounting position of the light receiving element itself can be adjusted in a three dimensional manner by the two dimensional adjustments of the light receiving element itself or the beam guide mirror and the one dimensional adjustment of the beam guide mirror or the light receiving element. Accordingly, the adjustment of the mounting position of the light receiving element can be stably attained in a simple method in comparison with the case where the light receiving element itself is adjusted in three dimensional directions.

As a comparison example with an embodiment of the present invention, instead of using the beam guide mirror, the mounting position of the light receiving element itself may be adjusted in a three dimensional manner by using another optical component disposed on the optical path for guiding the reflected light beam from the optical disk to the light receiving element, for example, by adjusting the position of the sensor lens in two dimensional directions or in one dimensional direction. However, when the optical component such as the sensor lens is adjusted, a problem may occur that its converging performance to the light receiving element is varied. According to an embodiment of the present invention, the beam guide mirror is only required to deflect the reflected light from the optical disk. Therefore, even when the mounting position of the beam guide mirror is adjusted, the converging performance to the light receiving element is not varied and thus a stable converging performance can be secured and the mounting position of the light receiving element can be stably adjusted. Further, in order to adjust the mounting position, the adjusted component is required to be formed to some extent larger. Since the beam guide mirror is formed in a comparatively simple structure, its design and production are easy in comparison with optical components such as a sensor lens having a complicated structure and thus component cost can be reduced.

In accordance with an embodiment of the present invention, the main body frame is provided with the light receiving element placing part on which the light receiving element is mounted so that its mounting position is adjustable from the upper face side and the beam guide mirror placing part on which the beam guide mirror is mounted so that its mounting position is adjustable from the bottom face side which is an opposite side to the upper face side. In this case, the mounting position of the light receiving element can be adjusted from the upper face side of the main body frame and the mounting position of the beam guide mirror can be adjusted from the bottom face side of the main body frame. In other words, the light receiving element and the beam guide mirror can be individually adjusted from different directions and thus workability of adjusting operations is enhanced.

In accordance with an embodiment of the present invention, the optical head device is provided with a mirror holder on which the beam guide mirror is mounted. The mirror holder is mounted on the light receiving face side of the light receiving element. Further, the main body frame may be provided with a light receiving element placing part on which the light receiving element is mounted such that its mounting position is adjustable from a bottom face side which is an opposite side to the upper face side. In other words, the beam guide mirror which is mounted on the mirror holder may be adjusted on the light receiving element in one dimensional direction.

Also, according to an embodiment of the present invention, there may be provided an adjusting method for an optical head device comprising preparing a laser beam emitting element, an objective lens for converging a laser beam which is emitted from the laser beam emitting element to an optical disk, a light receiving element which is provided with a light receiving face for receiving a reflected light from the optical disk, a beam guide mirror for guiding the reflected light to the light receiving face, and a main body frame on which at least the light receiving element and the beam guide mirror are mounted. The light receiving face of the light receiving element is disposed to face an incident direction of the reflected light to the objective lens. The mounting position of one of the light receiving element and the beam guide mirror is adjusted in parallel with the light receiving face and in two dimensional directions, and the mounting position of the other of the light receiving element and the beam guide mirror is adjusted in parallel with the light receiving face and in one dimensional direction.

In accordance with an embodiment of the present invention, the mounting position of one of the light receiving element and the beam guide mirror is adjusted in parallel with the light receiving face and in two dimensional directions and the mounting position of the other of the light receiving element and the beam guide mirror is adjusted in parallel with the light receiving face and in one dimensional direction. Therefore, the mounting position of the light receiving element can be adjusted in a three dimensional manner by the two dimensional adjustments of the light receiving element itself or the beam guide mirror and the one dimensional adjustment of the beam guide mirror or the light receiving element. Accordingly, the adjustment of the mounting position of the light receiving element can be stably attained in a simple method in comparison with the case where the light receiving element itself is adjusted in three dimensional directions. Further, a stable converging performance can be secured and the mounting position of the light receiving element can be easily adjusted in comparison with the case that an optical component except the beam guide mirror is adjusted. In addition, component cost can be reduced in comparison with the case that an optical component except the beam guide mirror is adjusted in one dimensional direction.

In an adjusting method for an optical head device in accordance with an embodiment of the present invention, the main body frame is provided with a light receiving element placing part on which the light receiving element is mounted such that its mounting position is adjustable from an upper face side facing the optical disk, and a beam guide mirror placing part on which the beam guide mirror is mounted such that its mounting position is adjustable from a bottom face side which is an opposite side to the upper face side. The mounting position of the light receiving element is adjusted from the upper face side and the mounting position of the beam guide mirror is adjusted from the bottom face side. In this case, since the light receiving element and the beam guide mirror can be individually adjusted from different directions, workability of adjusting operations is enhanced.

In an adjusting method for an optical head device in accordance with an embodiment of the present invention, the optical head device is further provided with a mirror holder on which the beam guide mirror is mounted and the main body frame is provided with a light receiving element placing part on which the light receiving element is mounted such that mounting position of the light receiving element is adjustable from a bottom face side which is an opposite side to the upper face side. The mirror holder is mounted on the light receiving face side of the light receiving element and both the mounting positions of the light receiving element and the beam guide mirror are adjusted from the bottom face side.

Further, according to an embodiment of the present invention, there may be provided an adjusting method for an optical head device including preparing a laser beam emitting element, an objective lens for converging a laser beam which is emitted from the laser beam emitting element to an optical disk, a light receiving element which is provided with a light receiving face for receiving a reflected light from the optical disk, a beam guide mirror for guiding the reflected light to the light receiving face, and a main body frame on which at least the light receiving element and the beam guide mirror are mounted. The light receiving face is disposed to face the incident direction of the reflected light to the objective lens and the mounting positions of the light receiving element and the beam guide mirror are adjusted by using a pseudo disk provided with a reflection surface which reflects a laser beam instead of the optical disk.

In this specification of an embodiment of the present invention, the “pseudo disk” may mean a small disk or object which is provided with a reflection surface for reflecting a laser beam and is small enough not to obstruct the adjustment of the mounting position of the light receiving element from the upper face side of the main body frame.

In accordance with an embodiment of the present invention, the mounting positions of the light receiving element and the beam guide mirror are adjusted by using a pseudo disk provided with a reflection surface which reflects a laser beam instead of the optical disk. The pseudo disk is, for example, a mirror which is disposed on the optical axis of the objective lens and is required to be provided with a reflection surface for reflecting the laser beam. Therefore, a small disk may be used in comparison with the optical disk. Accordingly, when the pseudo disk is used, the light receiving element can be easily accessed from the upper face side of the main body frame. Further, the adjusting portion of the light receiving element can be inspected with visual observation. Therefore, the mounting position of the light receiving element is easily adjusted and workability of the mounting operations is enhanced. In this case, the mounting accuracy of the pseudo disk in the focusing direction is required to be sufficiently secured in order to use the pseudo disk. Alternatively, when the mounting accuracy of the pseudo disk in the focusing direction is unable to be sufficiently secured, an adjusting lens having a larger focal depth than that of the objective lens is preferably used instead of the objective lens to use the pseudo disk.

As described above, in the optical head device in accordance with an embodiment of the present invention, one of the light receiving element and the beam guide mirror is disposed such that its mounting position is adjustable in two dimensional directions and the other of the light receiving element and the beam guide mirror is disposed such that its mounting position is adjustable in one dimensional direction. Therefore, the mounting position of the light receiving element can be adjusted in a three dimensional manner by two dimensional adjustments of the light receiving element itself or the beam guide mirror and one dimensional adjustment of the beam guide mirror or the light receiving element. Accordingly, the adjustment of the mounting position of the light receiving element can be stably attained in a simple method in comparison with the case where the light receiving element itself is adjusted in three dimensional directions.

In the adjusting method for an optical head device in accordance with an embodiment of the present invention, the mounting position of one of the light receiving element and the beam guide mirror is adjusted in two dimensional directions and the mounting position of the other of the light receiving element and the beam guide mirror is adjusted in one dimensional direction. Therefore, the mounting position of the light receiving element can be adjusted in a three dimensional manner. Accordingly, the adjustment of the mounting position of the light receiving element can be stably attained in a simple method in comparison with the case where the light receiving element itself is adjusted in three dimensional directions.

In addition, in the adjusting method for an optical head device in accordance with an embodiment of the present invention, the mounting positions of the light receiving element and the beam guide mirror are adjusted by using a pseudo disk which is smaller than the optical disk instead of the optical disk. Therefore, the light receiving element can be easily accessed from the upper face side of the main body frame and the adjusting portion of the light receiving element can be inspected with visual observation. Accordingly, the mounting position of the light receiving element is easily adjusted and workability of the mounting operations is enhanced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic structural view showing an optical head device in accordance with a first embodiment of the present invention.

FIG. 2 is a perspective view showing the optical head device shown in FIG. 1 which is viewed from an upper face side.

FIG. 3 is a bottom view showing the optical head device shown in FIG. 1.

FIG. 4 is an enlarged side view showing the mounting parts of a light receiving element and a beam guide mirror in the optical head device shown in FIG. 1.

FIG. 5 is a perspective view showing an optical head device in accordance with a second embodiment of the present invention which is viewed from an upper face side.

FIG. 6 is a perspective view showing the optical head device shown in FIG. 5 which is viewed from a bottom face side.

FIG. 7 is a perspective view showing the state where an optical system is mounted on a second frame in the optical head device shown in FIG. 5 which is viewed from a bottom face side.

### DETAILED DESCRIPTION OF THE PREFERRED EMBODIMENTS

Several embodiments of the present invention will be described in detail below with reference to the accompanying drawings.

### First Embodiment

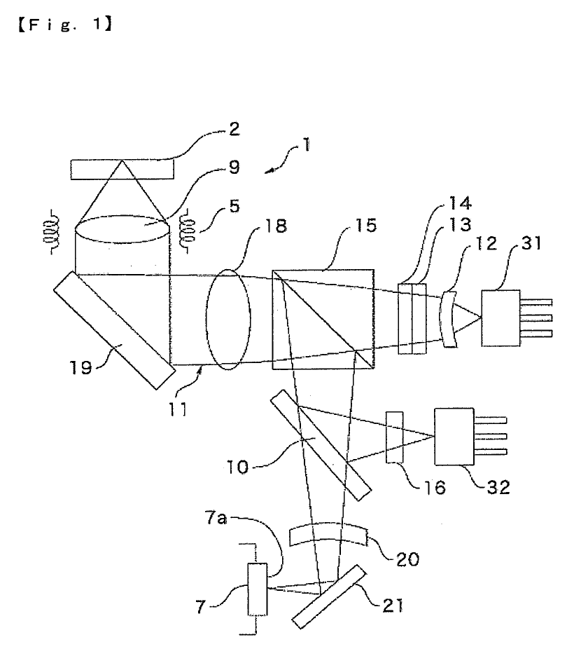

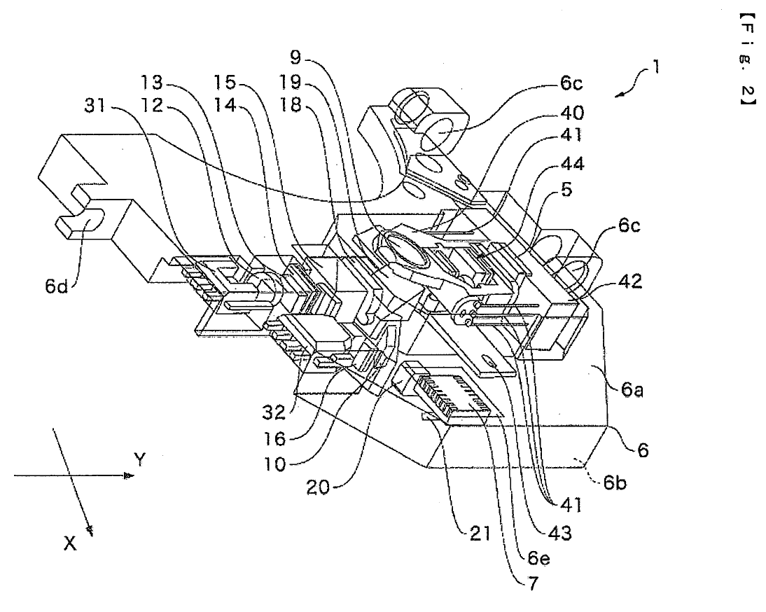

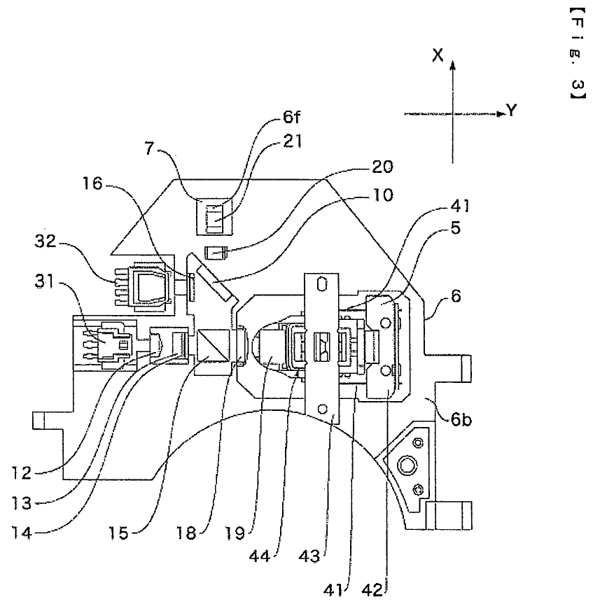

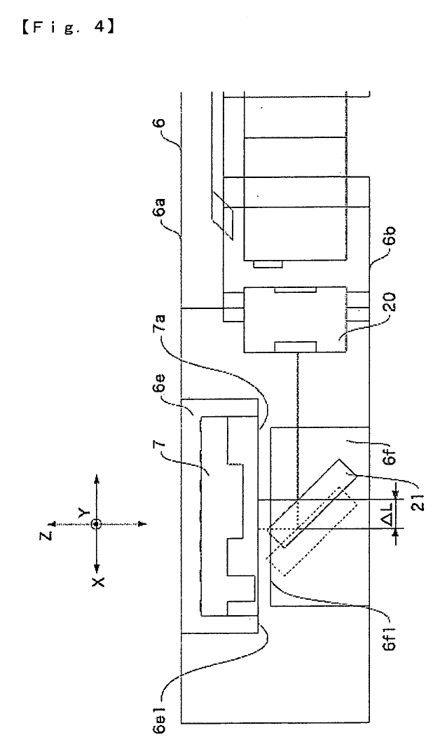

FIG. 1 is a schematic structural view showing an optical head device in accordance with a first embodiment of the present invention. FIG. 2 is a perspective view showing the optical head device shown in FIG. 1 which is viewed from an upper face side. FIG. 3 is a bottom view showing the optical head device shown in FIG. 1. FIG. 4 is an enlarged side view showing the mounting parts of a light receiving element and a beam guide mirror in the optical head device shown in FIG. 1.

An optical head device 1 in accordance with the first embodiment of the present invention is used for recording and reproducing information to and from an optical disk 2 such as a CD or a DVD. The optical head device 1 includes an objective lens drive device 5 which drives an objective lens 9 in a tracking direction, a focusing direction and a tilt direction for converging laser beams emitted from the first and the second laser beam emitting elements 31, 32 as light sources to an optical disk 2. The optical head device 1 also includes a main body frame 6 which holds the objective lens drive device 5 on its upper face side and on which the first and the second laser beam emitting elements 31, 32 and a prescribed optical system described below are mounted. The first and the second laser beam emitting elements 31, 32 are a laser beam emitting element for DVD which emits the first laser beam with a wavelength of 650 nm or 635 nm (short wavelength) and a laser beam emitting element for CD which emits the second laser beam with a wavelength of 760-800 nm (long wavelength).

The first laser beam emitted from the first laser beam emitting element 31 is guided to a common optical path 11 directing to the optical disk 2 through a prism 15 which is a polarizing beam splitter as an optical path composing element and converged on the recording face of the optical disk 2 through the objective lens 9. The second laser beam emitted from the second laser beam emitting element 32 is guided to the common optical path 11 by a half mirror 10 and the prism 15 as an optical path splitting element and converged on the recording face of the optical disk 2 through the objective lens 9. The return light beam (reflected light) of the laser beam reflected by the optical disk 2 is incident on the half mirror 10 through the prism 15 and separated by the half mirror 10 to be guided to the light receiving face 7a of the first light receiving element 7.

More concretely, a relay lens 12, a ½ wavelength plate 13, a first grating lens 14, the prism 15, a collimating lens 18, a raising mirror 19 and the objective lens 9 are disposed on the optical path directing to the optical disk 2 from the first laser beam emitting element 31 on the main body frame 6. Therefore, the first laser beam emitted from the first laser beam emitting element 31 transmits through the relay lens 12, the ½ wavelength plate 13, the first grating lens 14 and the prism 15, and then the first laser beam is converted into a parallel light beam by the collimating lens 18. After that, the first laser beam is guided upward with the raising mirror 19 and converged on the recording face of the optical disk 2 through the objective lens 9 as an optical spot.

A second grating lens 16, the half mirror 10, the prism 15, the collimating lens 18, the raising mirror 19 and the objective lens 9 are disposed on the optical path directing to the optical disk 2 from the second laser beam emitting element 32. Therefore, the second laser beam emitted from the second laser beam emitting element 32 transmits through the second grating lens 16, and then a part of the second laser beam is reflected by the half mirror 10 and reflected by the prism 15. After that, the second laser beam is converted into a parallel light beam by the collimating lens 18, and then guided upward with the raising mirror 19 and converged on the recording face of the optical disk 2 through the objective lens 9 as an optical spot.

The reflected light beam by the optical disk 2 is guided on the optical path in the reverse direction. In other words, the reflected light beam is guided to the prism 15 through the objective lens 9, the raising mirror 19, and the collimating lens 18 and then reflected by the prism 15 to be incident on the half mirror 10. After that, the light beam transmitted through the half mirror 10 transmits through the sensor lens 20, and then raised by a beam guide mirror 21 to reach to the light receiving face 7a of the first light receiving element 7.

The main body frame 6 which may be made of metal material is formed in a flat shape provided with an upper face 6a facing the optical disk 2 and a bottom face 6b which is an opposite face to the upper face 6a. Guide holes 6c, which are circular holes and a guide part 6d which protrudes in a U-shape are formed on both end parts of the main body frame 6. The optical head device 1 can be moved in a radial direction of the optical disk 2 along guide shafts (not shown in the drawing) which are respectively passed through the guide holes 6c, and the guide part 6d. Further, the main body frame 6 is provided with a light receiving element placing part 6e which is formed in a concave shape on the upper face 6a side and a beam guide mirror placing part 6f which is formed in a concave shape on the bottom face 6b side (see FIG. 4).

On the main body frame 6 are mounted the first and the second laser beam emitting elements 31, 32, the relay lens 12, the ½ wavelength plate 13, the first grating lens 14, the second grating lens 16, the prism 15, the half mirror 10, the collimating lens 18, the raising mirror 19, the sensor lens 20, the beam guide mirror 21 and the first light receiving element 7.

A light receiving element placing part 6e is provided with a placing face 6e1 (see FIG. 4). The first light receiving element 7 is disposed on the placing face 6e1 such that the light receiving face 7a faces the incident direction of the reflected light to the objective lens 9, i.e., downward direction in FIG. 4. The mounting position of the first light receiving element 7 is capable of being adjusted from the upper face 6a side. Further, when the tracking direction of the optical disk 2 is set to be an X-direction and the direction which is parallel with the light receiving face 7a and perpendicular to the tracking direction is set to be a Y-direction, the mounting position of the first light receiving element 7 is adjustable in parallel with the light receiving face 7a and in two dimensional directions of the X-direction and the Y-direction.

A beam guide mirror placing part 6f is provided with a placing face 6f 1 (see FIG. 4). The beam guide mirror 21 is disposed on the placing face 6f1 so as to raise the reflected light toward the light receiving face 7a. The mounting position of the beam guide mirror 21 is adjustable from the bottom face 6b side in one dimensional direction of the X-direction and in parallel with the light receiving face 7a. The beam guide mirror 21 in an embodiment of the present invention is a total reflection mirror.

The first light receiving element 7 is disposed such that its light receiving face 7a faces in the downward direction. Therefore, the reflected light from the optical disk 2 which is guided to the light receiving face 7a of the first light receiving element 7 by the beam guide mirror 21 is deflected to be substantially parallel with the disk face of the optical disk 2 by the raising mirror 19 and passes on the bottom face 6b side of the main body frame 6.

The objective lens drive device 5 includes a lens holder 40 which holds the objective lens 9, a holder support member 42 movably supporting the lens holder 40 in a tracking direction, a focusing direction and a tilt direction with six wires 41 such that both sides of the lens holder 40 are supported by three wires which are disposed in the vertical direction, and a yoke 43 which constructs the frame for the objective lens drive device 5. The yoke 43 is attached on the bottom face 6b side of the main body frame 6. Therefore, the objective lens drive device 5 is mounted on the main body frame 6 such that the objective lens 9 is disposed on the upper face 6a side of the main body frame 6. The holder support member 42 is fixed to and supported by the main body frame 6 or the yoke 43.

The objective lens drive device 5 is provided with a magnetic drive circuit 44 which is constructed by drive coils mounted on the lens holder 40 and drive magnets mounted on the yoke 43. The objective lens 9 supported by the lens holder 40 can be driven in the tracking direction, the focusing direction and the tilt direction with respect to the optical disk 2 by controlling energization to the drive coils.

An adjusting method of the mounting position of the first light receiving element 7 in the optical head device 1 as constructed above will be described below.

In order to adjust the mounting position of the first light receiving element 7, a pseudo disk (not shown in the drawing) provided with a reflection surface which reflects a laser beam is used instead of the optical disk 2. The pseudo disk is, for example, a mirror which is disposed on the optical axis of the objective lens 9 and is provided with a reflection surface for reflecting the laser beam. The pseudo disk is only required to reflect the laser beam emitted from the objective lens 9 and thus a small disk in comparison with the optical disk 2 may be used. In an embodiment of the present invention, a small-sized pseudo disk is used so as not to cover the light receiving element placing part 6e of the main body frame 6.

The focal depth of the objective lens 9 is commonly small. Therefore, when the mounting position of the first light receiving element 7 is adjusted by using the objective lens 9, a high degree of mounting accuracy of the pseudo disk in the focusing direction is required to use the pseudo disk. Accordingly, in an embodiment of the present invention, before the objective lens drive device 5 is fixed to the main body frame 6, the mounting position of the first light receiving element 7 is adjusted by using an adjusting lens (not shown in the drawing) with a larger focal depth than that of the objective lens 9 instead of the objective lens 9. More concretely, the mounting position of the first light receiving element 7 is adjusted in the state of the optical head device where the objective lens drive device 5 is not yet fixed to the main body frame 6, an adjusting lens and a pseudo disk are held by prescribed jigs. Alternatively, when the mounting accuracy of the pseudo disk in the focusing direction is sufficiently ensured by using a jig, the objective lens drive device 5 may be mounted on the main body frame 6 and then the mounting position of the first light receiving element 7 may be adjusted by using the objective lens 9.

First, the objective lens drive device 5 is fixed to the main body frame 6, while the adjusting lens and the pseudo disk are held by prescribed jigs. After that, a laser beam is successively emitted from the first and the second laser beam emitting elements 31, 32 and the mounting position of the first light receiving element 7 is adjusted while the reflected light from the pseudo disk is detected.

More concretely, first, the position of the first light receiving element 7 is adjusted along the placing face 6e1 and in parallel with the light receiving face 7a in two dimensional directions (X-direction and Y-direction) by using a prescribed jig and the optical axis of the light receiving face 7a is matched with the optical axis of the reflected light which is incident on the light receiving face 7a. This adjustment of the position is performed from the upper face 6a side of the main body frame 6. The pseudo disk is so small that the light receiving element placing part 6e of the main body frame 6 is not covered and thus the adjustment of the mounting position is not obstructed by the pseudo disk. Further, the adjusting portion of the first light receiving element 7 can be inspected with visual observation.

Next, the position of the beam guide mirror 21 is adjusted in one dimensional direction (X-direction) in parallel with the light receiving face 7a by using a prescribed jig. The adjustment of the position is performed from the bottom face 6b side of the main body frame 6. When the position of the beam guide mirror 21 is adjusted in the X-direction, the optical path length of the reflected light reaching to the light receiving face 7a is changed. For example, as shown in FIG. 4, when the beam guide mirror 21 is moved by the length of ΔL in the X-direction, in other words, when the beam guide mirror 21 is moved from the position shown by the solid line in FIG. 4 to the position shown by the broken line, the optical path length of the reflected light reaching to the light receiving face 7a changes by the length of ΔL. Therefore, when the direction perpendicular to the X-direction and the Y-direction is set to be a Z-direction, the mounting position of the first light receiving element 7 can be equivalently adjusted in the Z-direction by the beam guide mirror 21 which is adjusted in the X-direction.

Next, the first light receiving element 7 is moved in the X-direction by the moving length of the beam guide mirror 21 in the X-direction and the optical axis of the light receiving face 7a is matched with the optical axis of the reflected light which is incident on the light receiving face 7a. Thereby, the adjustment of the mounting position of the first light receiving element 7 is completed.

As described above, in the optical head device 1 in an embodiment of the present invention, the first light receiving element 7 is disposed such that its mounting position is adjustable in parallel with the light receiving face 7a and in two dimensional directions and the beam guide mirror 21 is disposed such that its mounting position is adjustable in parallel with the light receiving face 7a of the first light receiving element 7 and in one dimensional direction. Therefore, the mounting position of the first light receiving element 7 can be adjusted in a three dimensional manner by the two dimensional adjustments of the first light receiving element 7 itself and the one dimensional adjustment of the beam guide mirror 21. Accordingly, the adjustment of the mounting position of the first light receiving element 7 can be stably attained in a simple method in comparison with the case where the first light receiving element 7 itself is adjusted in three dimensional directions.

As a comparison example, instead of using the beam guide mirror 21, the mounting position of the first light receiving element 7 may be adjusted in a three dimensional manner by using another optical component disposed on the optical path for guiding the reflected light beam from the optical disk 2 to the first light receiving element 7, for example, by adjusting the position of the sensor lens 20 in one dimensional direction. However, when the optical component such as the sensor lens 20 is adjusted, a problem may occur that its converging performance to the first light receiving element 7 is varied. On the other hand, in accordance with an embodiment of the present invention, the beam guide mirror 21 is a total reflection mirror. Therefore, even when the mounting position of the beam guide mirror 21 is adjusted, the converging performance to the first light receiving element 7 is not varied and thus a stable converging performance can be secured and the mounting position of the first light receiving element 7 can be stably adjusted. Further, in order to adjust the mounting position, the adjusting component is required to be formed larger to some extent. Since the beam guide mirror 21 is formed in a comparatively simple structure, its design and production are easy in comparison with optical components such as the sensor lens 20 having a complicated structure and thus component cost can be reduced.

In an embodiment of the present invention, the main body frame 6 is provided with the light receiving element placing part 6e on which the first light receiving element 7 is mounted so that its mounting position is adjustable from the upper face 6a side and the beam guide mirror placing part 6f on which the beam guide mirror 21 is mounted so that its mounting position is adjustable from the bottom face 6b side. Therefore, the mounting position of the first light receiving element 7 can be adjusted from the upper face 6a side of the main body frame 6 and the mounting position of the beam guide mirror 21 can be adjusted from the bottom face 6b side of the main body frame 6. In other words, the first light receiving element 7 and the beam guide mirror 21 can be individually adjusted from different directions and thus workability of adjusting operations enhanced.

Especially in an embodiment of the present invention, the pseudo disk is used instead of the optical disk 2 at the time of adjusting the mounting position of the first light receiving element 7 and the beam guide mirror 21. The pseudo disk is small enough not to cover the light receiving element placing part 6e of the main body frame 6 and thus the first light receiving element 7 can be easily accessed from the upper face 6a side of the main body frame 6. Further, the adjusting portion of the first light receiving element 7 can be inspected with visual observation. Therefore, the mounting position of the first light receiving element 7 is easily adjusted and workability of the mounting operations enhanced.

Further, in an embodiment of the present invention, before the objective lens drive device 5 is fixed to the main body frame 6, the mounting position of the first light receiving element 7 is adjusted by using the adjusting lens having a larger focal depth than that of the objective lens 9 instead of the objective lens 9. Therefore, even when the mounting accuracy of the pseudo disk in the focusing direction cannot be sufficiently secured, the mounting position of the first light receiving element 7 can be adjusted by using the pseudo disk.

### Second Embodiment

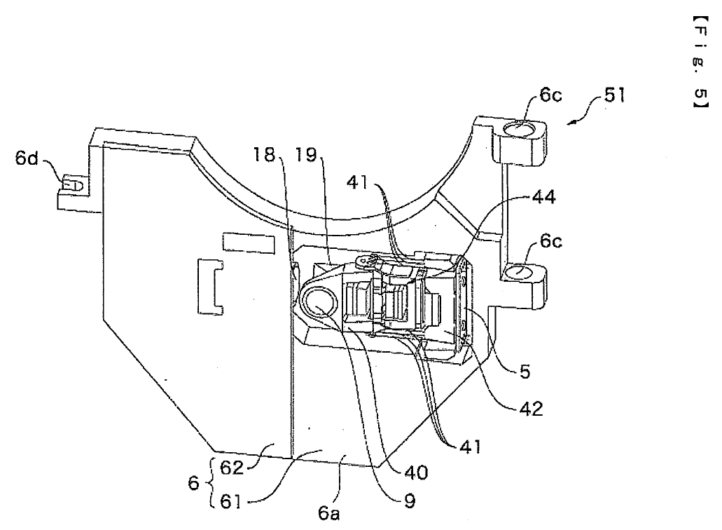

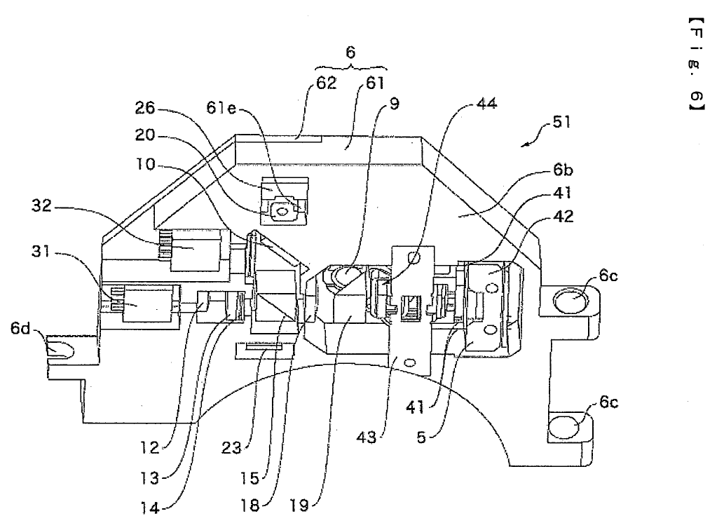

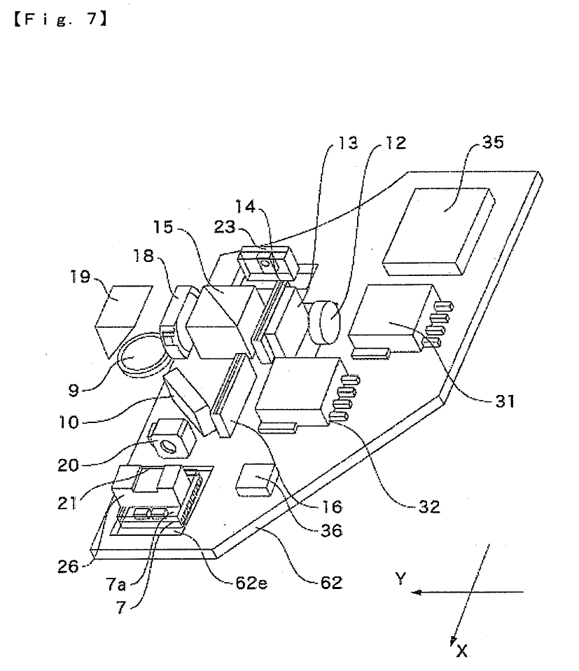

FIG. 5 is a perspective view showing an optical head device in accordance with a second embodiment of the present invention which is viewed from an upper face side. FIG. 6 is a perspective view showing the optical head device shown in FIG. 5 which is viewed from a bottom face side. FIG. 7 is a perspective view showing the state where an optical system is mounted on a second frame in the optical head device shown in FIG. 5 which is viewed from a bottom face side.

The optical head device 51 shown in FIG. 5 also performs recording or reproducing information to or from the optical disk 2 such as a CD or a DVD. Main differences between the optical head device 1 in the first embodiment and the optical head device 51 in the second embodiment are the structure of the main body frame 6 and the structure of the placing part for the optical system. Since the basic structure of the optical head device 51 including the optical system is the same as the optical head device 1 the same notational symbol is used for the same structural member and its description is omitted. The optical head device 51 in the second embodiment will be described below mainly on the above-mentioned differences.

The optical system of the optical head device 51 in the second embodiment of the present invention is different from that of the optical head device 1 in that a second light receiving element 23 to monitor and provide feedback for adjusting the outputs of the first and the second laser beam emitting elements 31, 32 is also provided. The second light receiving element 23 for monitoring is disposed at a position where the second light receiving element 23 receives the first laser beam which is emitted from the first laser beam emitting element 31 and partially reflected by the prism 15 and receives the second laser beam which is emitted from the second laser beam emitting element 32 and partially transmits through the prism 15 (see FIG. 7).

The main body frame 6 is constructed of a first frame 61 made of resin and a second frame 62 made of metal. The second frame 62 is fixed to the first frame 61 on the upper face 6a side of the main body frame 6 between the objective lens 9 and a guide part 6d.

Guide holes 6c, which are circular holes and the guide part 6d which is protruded in a U-shape are formed on both end parts of the first frame 61. The optical head device 51 is capable of moving in a radial direction of the optical disk 2 along guide shafts (not shown in the drawing) which are respectively passed through the guide holes 6c, and the guide part 6d. An aperture part 61e is formed in the first frame 61 so as to be capable of adjusting the mounting position of the first light receiving element 7 from the bottom face 6b side (see FIG. 6).

The second frame 62 is a flat plate member which is made of metal such as sheet steel and having a high coefficient of thermal conductivity. A placing face 62e on which the first light receiving element 7 is mounted is formed in a concave shape in the second frame 62. A light receiving element placing part for mounting the first light receiving element 7 is constructed of the placing face 62e and the aperture part 61e formed in the first frame 61. The second frame 62 may be formed by zinc dies casting.

On the second frame 62 are mounted the first and the second laser beam emitting elements 31, 32, the relay lens 12, the ½ wavelength plate 13, the first grating lens 14, the second grating lens 16, the prism 15, the half mirror 10, the collimating lens 18, the second light receiving element 23 for monitoring, the sensor lens 20, the beam guide mirror 21 and the first light receiving element 7. Further, a driver 35 for driving the first and the second laser beam emitting elements 31, 32 and a high-frequency current superimposing IC 36 for the first and the second laser beam emitting elements 31, 32 are mounted on the second frame 62. The raising mirror 19 is mounted on the first frame 61.

The first light receiving element 7 is disposed on the placing face 62e of the second frame 62 such that the light receiving face 7a faces the incident direction of the reflected light to the objective lens 9 (upward direction in FIG. 7). The mounting position of the first light receiving element 7 is adjustable along the placing face 62e from the bottom face 6b side. Further, when the tracking direction of the optical disk 2 is set to be the X-direction and the direction parallel to the light receiving face 7a and perpendicular to the tracking direction is set to be the Y-direction, the mounting position of the first light receiving element 7 is adjustable so as to be parallel with the light receiving face 7a in the two dimensional directions of the X-direction and the Y-direction.

A mirror holder 26 on which the beam guide mirror 21 is mounted is mounted on the light receiving face 7a of the first light receiving element 7. The beam guide mirror 21 is disposed in the mirror holder 26 so as to raise the reflected light toward the light receiving face 7a. The mounting position of the beam guide mirror 21 is adjustable along the light receiving face 7a in one dimensional direction of the X-direction through the mirror holder 26. Further, the mounting position of the beam guide mirror 21 is adjustable from the bottom face 6b side through the mirror holder 26.

In the optical head device 51 constructed as described above, the mounting position of the first light receiving element 7 is also adjusted by using the pseudo disk and the adjusting lens. In other words, the optical head device without the objective lens drive device 5 being fixed to the main body frame 6, the adjusting lens and the pseudo disk are held by prescribed jigs. In this state, a laser beam is successively emitted from the first and the second laser beam emitting elements 31, 32 and the mounting position of the first light receiving element 7 is adjusted while the reflected light beam from the pseudo disk is detected.

More concretely, while the position of the first light receiving element 7 is adjusted along the placing face 62e and in parallel with the light receiving face 7a in two dimensional directions (X-direction and Y-direction) by using a prescribed jig, the position of the mirror holder 26 is adjusted in one-dimensional direction (X-direction) in parallel with the light receiving face 7a by using a prescribed jig. In this manner, the optical axis of the light receiving face 7a is matched with the optical axis of the reflected light which is incident on the light receiving face 7a and the optical path length of the reflected light reaching to the light receiving face 7a is adjusted. This positional adjustment is performed from the bottom face 6b side of the main body frame 6.

As described above, also in the optical head device 51 in the second embodiment of the present invention, the first light receiving element 7 is disposed such that its mounting position is adjustable in parallel with the light receiving face 7a and in two dimensional directions and the beam guide mirror 21 is disposed such that its mounting position is adjustable in parallel with the light receiving face 7a of the first light receiving element 7 and in one dimensional direction. Therefore, the mounting position of the first light receiving element 7 can be adjusted in a three dimensional manner by the two dimensional adjustments of the first light receiving element 7 itself and the one dimensional adjustment of the beam guide mirror 21. Accordingly, the adjustment of the mounting position of the first light receiving element 7 can be stably attained in a simple method in comparison with the case where the first light receiving element 7 itself is adjusted in three dimensional directions.

### Other Embodiments

The present invention is not limited to the embodiments described above, and many modifications can be made without departing from the subject matter of the present invention. For example, in an embodiment described above, the first light receiving element 7 is disposed such that its mounting position is adjustable in parallel with the light receiving face 7a and in two dimensional directions and the beam guide mirror 21 is disposed such that its mounting position is adjustable in parallel with the light receiving face 7a of the first light receiving element 7 and in one dimensional direction. However, the beam guide mirror 21 may be disposed such that its mounting position is adjustable in parallel with the light receiving face 7a and in two dimensional directions and the first light receiving element 7 is disposed such that its mounting position is adjustable in parallel with the light receiving face 7a and in one dimensional direction.

In the second embodiment described above, the second frame 62 on which a prescribed optical system is mounted may be constructed as an optical system unit and the mounting position of the first light receiving element 7 may be adjusted in the state where the optical system unit is held by prescribed jigs together with the adjusting lens and the pseudo disk. In this case, the adjustment of mounting position of the first light receiving element 7 is not required after the second frame 62 is fixed to the first frame 61. In other words, the adjustment of the mounting position of the first light receiving element 7 is completed without the first frame 61 which may cause an obstacle at the time of the adjustment of the mounting position of the first light receiving element 7. Therefore, the adjusting operations of the mounting position of the first light receiving element 7 are simplified.

In addition, as described in the second embodiment of the present invention, when the mounting position of the first light receiving element 7 is adjusted from the bottom face 6b side of the main body frame 6, the pseudo disk is not always required and the mounting position of the first light receiving element 7 may be adjusted by using the optical disk 2.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device for use with an optical disk comprising:
at least one laser beam emitting element;
an objective lens for converging a laser beam which is emitted from the laser beam emitting element to an optical disk;
a light receiving element which is provided with a light receiving face for receiving a reflected light from an optical disk, the light receiving face being disposed to face an incident direction of the reflected light to the objective lens;
a beam guide mirror for guiding the reflected light to the light receiving face; and
a main body frame on which at least the light receiving element and the beam guide mirror are mounted;
wherein one of the light receiving element and the beam guide mirror is disposed such that its mounting position is adjustable in parallel with the light receiving face and in two dimensional directions, and
the other of the light receiving element and the beam guide mirror is disposed such that its mounting position is adjustable in parallel with the light receiving face and in one dimensional direction.

2. The optical head device according to claim 1, wherein the main body frame is provided with a light receiving element placing part on which the light receiving element is mounted such that its mounting position is adjustable from an upper face side facing the optical disk, and a beam guide mirror placing part on which the beam guide mirror is mounted such that its mounting position is adjustable from a bottom face side which is an opposite side to the upper face side.

3. The optical head device according to claim 1, further comprising
a mirror holder on which the beam guide mirror is mounted, the mirror holder being mounted on the light receiving face side of the light receiving element,
wherein the main body frame is provided with a light receiving element placing part on which the light receiving element is mounted such that its mounting position is adjustable from a bottom face side which is an opposite side to the upper face side.

4. An adjusting method for an optical head device comprising:
preparing a laser beam emitting element, an objective lens for converging a laser beam which is emitted from the laser beam emitting element to an optical disk, a light receiving element which is provided with a light receiving face for receiving a reflected light from the optical disk, a beam guide mirror for guiding the reflected light to the light receiving face, and a main body frame on which at least the light receiving element and the beam guide mirror are mounted;
disposing the light receiving face so as to face an incident direction of the reflected light to the objective lens;
adjusting mounting position of one of the light receiving element and the beam guide mirror in parallel with the light receiving face and in two dimensional directions; and
adjusting mounting position of the other of the light receiving element and the beam guide mirror in parallel with the light receiving face and in one dimensional direction.

5. The adjusting method for an optical head device according to claim 4, wherein
the main body frame is provided with a light receiving element placing part on which the light receiving element is mounted such that its mounting position is adjustable from an upper face side facing the optical disk, and a beam guide mirror placing part on which the beam guide mirror is mounted such that its mounting position is adjustable from a bottom face side which is an opposite side to the upper face side, and
mounting position of the light receiving element is adjusted from the upper face side and mounting position of the beam guide mirror is adjusted from the bottom face side.

6. The adjusting method for an optical head device according to claim 4, further comprising
preparing a mirror holder on which the beam guide mirror is mounted;
providing in the main body frame a light receiving element placing part on which the light receiving element is mounted such that mounting position of the light receiving element is adjustable from a bottom face side which is an opposite side to the upper face side which is facing the optical disk;
mounting the mirror holder on the light receiving face side of the light receiving element; and
adjusting both mounting positions of the light receiving element and the beam guide mirror from the bottom face side.

7. An adjusting method for an optical head device comprising:
preparing a laser beam emitting element, an objective lens for converging a laser beam which is emitted from the laser beam emitting element to an optical disk, a light receiving element which is provided with a light receiving face for receiving a reflected light from the optical disk, a beam guide mirror for guiding the reflected light to the light receiving face, and a main body frame on which at least the light receiving element and the beam guide mirror are mounted;
disposing the light receiving face so as to face an incident direction of the reflected light to the objective lens, and
adjusting mounting positions of the light receiving element and the beam guide mirror by using a pseudo disk provided with a reflection surface which reflects a laser beam instead of the optical disk.

8. The optical head device according to claim 1, further comprising a second light receiving element to monitor and provide feedback for adjusting the output of the at least one laser beam emitting element.

9. The optical head device according to claim 1, in which the main body frame comprises a metal frame made of metal and a resin frame made of resin, wherein at least the light receiving element and the beam guide mirror are mounted.
